(19) United States
(12) Patent Application Publication
(10) Pub. No.: US 2026/0323189 A1
(43) Pub. Date: Oct. 15, 2026

(54) IMAGING DEVICE

(71) Applicant: SONY SEMICONDUCTOR SOLUTIONS CORPORATION, KANAGAWA (JP)

(72) Inventors: MAMORU SATO, KANAGAWA (JP); KATSUHIKO HANZAWA, KANAGAWA (JP); TATSUYA ISHIKAWA, KANAGAWA (JP)

(21) Appl. No.: 19/104,312

(22) PCT Filed: Jun. 30, 2023
(86) PCT No.: PCT/JP2023/024422

§ 371 Date: Feb. 17, 2025

(30) Foreign Application Priority Data
Aug. 25, 2022 (JP) 2022-134126

(51) Int. Cl. H04N 25/78; H04N 25/709; H04N 25/772

(52) U.S. Cl. CPC H04N 25/78; H04N 25/709; H04N 25/772

(57) ABSTRACT

Capacitive load reading is enabled while suppressing an increase in current consumption and settling time.

An imaging device includes: a signal line that changes in potential on the basis of a charge accumulated according to a current passing when a signal is read from a pixel; a signal line transistor electrically connected to the signal line; and a voltage generation unit connected in series to the signal line transistor and being capable of generating a voltage higher than 0 V. The pixel may include a photodiode; a transfer transistor that transfers a charge accumulated in the photodiode to a floating diffusion; a reset transistor that resets the floating diffusion; an amplification transistor that outputs a signal corresponding to the potential of the floating diffusion; and a selection transistor connected between the amplification transistor and the signal line.

### TECHNICAL FIELD

The present technique relates to an imaging device. The present technique relates to an imaging device capable of capacitive load reading.

### BACKGROUND ART

A known capacitive load reading method uses a capacity for the load of a source follower during reading of a signal from a pixel. As such a capacitive load reading method, for example, an imaging device is proposed such that a constant current is passed through an output line by a constant current source and the source of an amplification transistor is connected to the output line after the voltage of the output line is reset by a reset unit (for example, see PTL 1).

### CITATION LIST

### Patent Literature

### [PTL 1]

JP 2021-40270 A

### SUMMARY

### Technical Problem

In the conventional art, however, an output-line reset voltage generation circuit that generates an output-line reset voltage is provided to reset the voltage of the output line by the reset unit, so that current consumption may increase accordingly. If the output-line reset voltage generation circuit is omitted and the output-line reset voltage is set at a ground voltage, the settling time may increase.

The present technique has been devised in view of such circumstances. An object of the present technique is to enable capacitive load reading while suppressing an increase in current consumption and settling time.

### Solution to Problem

The present technique has been made to solve the problem. A first aspect of the present technique is an imaging device including: a signal line that changes in potential on the basis of a charge accumulated according to a current passing when a signal is read from a pixel; a signal line transistor electrically connected to the signal line; and a voltage generation unit connected in series to the signal line transistor and being capable of generating a voltage higher than 0 V. This provides the effect of setting the signal line at a voltage higher than 0 V when the signal line is reset.

Furthermore, in the first aspect, the potential of the signal line may be the potential of the parasitic capacitance of the signal line. This provides the effect of capacitive load reading without adding a capacitive element to the signal line.

Moreover, in the first aspect, the pixel may include a photodiode; a transfer transistor that transfers a charge accumulated in the photodiode to a floating diffusion; a reset transistor that resets the floating diffusion; an amplification transistor that outputs a signal corresponding to the potential of the floating diffusion; and a selection transistor connected between the amplification transistor and the signal line. This provides the effect of forming a source follower with the pixel when a signal is read from the pixel.

Additionally, in the first aspect, the voltage generation unit may include a diode-connected transistor. This provides the effect of raising the potential of the signal line according to the forward voltage of the diode-connected transistor when the signal line is reset.

Furthermore, in the first aspect, the voltage generation unit may include a plurality of diode-connected transistors connected in series in varying numbers. This provides the effect of switching the voltage of the signal line when the signal line is reset.

Moreover, in the first aspect, the voltage generation unit sets the reset level of the signal line upon reading of a reset level from the pixel such that the reset level of the signal line is equal to or higher than a reset level of the signal line upon reading of a signal level from the pixel. This provides the effect of shortening a settling time when the reset level is read from the pixel.

Furthermore, in the first aspect, the imaging device may further include a comparator that compares the potential of the signal line and a ramp signal. This provides the effect of detecting a signal read from the pixel, on the basis of the potential of the signal line.

Moreover, in the first aspect, the imaging device may further include a comparator that compares the potentials of the signal lines provided in different columns. This provides the effect of detecting the edge of a subject on the basis of capacitive load reading.

Furthermore, in the first aspect, the imaging device may further include a constant-current transistor that is electrically connectable to the signal line and passes a constant current on the basis of a source follower formed between the pixel and the constant-current transistor. This provides the effect of constant-current reading when capacitive load reading is not performed.

Additionally, in the first aspect, the constant-current transistor may be turned on in constant current reading using the constant-current transistor, and the constant-current transistor may be turned off in capacitive load reading using the voltage generation unit. This provides the effect of switching between capacitive load reading and constant-current reading.

Furthermore, in the first aspect, the imaging device may further include a sample hold circuit that operates the signal line transistor as a constant-current transistor; and a switch that switches the connection of the signal line transistor between the voltage generation unit and the ground potential. This provides the effect of sharing the signal line transistor in constant-current reading and capacitive load reading.

In the first aspect, in constant-current reading, the connection of the signal line transistor may be switched to the ground potential and the signal line transistor is turned on, and in capacitive load reading, the connection of the signal line transistor may be switched to the voltage generation unit and the signal line transistor may be turned off after the signal line is reset. This provides the effect of switching between capacitive load reading and constant-current reading.

Moreover, in the first aspect, the voltage generation unit may include a series transistor connected in series to the signal line transistor; and a switching transistor that switches between the gate and drain of the series transistor. This provides the effect of sharing the series transistor in constant-current reading and capacitive load reading.

Additionally, in the first aspect, the switching transistor may be turned off in constant current reading, and the switching transistor may be turned on in capacitive load reading. This provides the effect of switching between capacitive load reading and constant-current reading.

In the first aspect, the imaging device may include a chip on which the pixel is formed, wherein the signal line transistor is formed on the chip. This provides the effect of reducing variations in the characteristics of the signal line transistor and the characteristics of pixel transistors.

Furthermore, in this first aspect, the voltage generation unit may be formed on the chip. This provides the effect of reducing variations in the characteristics of the voltage generation unit and the characteristics of the pixel transistors.

Additionally, in the first aspect, the imaging device may further include a pixel array unit including the pixels arranged in a matrix form in the row direction and the column direction, wherein the plurality of signal lines may be provided in the row direction such that the signal lines are routed in the column direction, and the signal line transistor may be provided for each of the signal lines. This provides the effect of resetting the potentials of the signal lines for each of the signal lines.

Furthermore, in the first aspect, the voltage generation unit may be provided for each of the signal lines in different columns. This provides the effect of setting the potentials of the signal lines for each of the signal lines.

Moreover, in the first aspect, the voltage generation unit may be shared among the plurality of signal lines in different columns. This provides the effect of reducing the number of voltage generation unit with respect to the number of columns.

Additionally, in the first aspect, the imaging device may further include a short-circuit line that short-circuits the voltage generation unit provided for each of the signal lines in different columns. This provides the effect of reducing variations in the potentials of the signal lines in the respective columns.

### Brief Description of Drawings

FIG. 1 is a block diagram illustrating a configuration example of a camera to which an imaging device according to a first embodiment is applied.

FIG. 2 is a block diagram illustrating a configuration example of a solid-state imaging device according to the first embodiment.

FIG. 3 is a block diagram illustrating a circuit configuration example of a pixel provided in the solid-state imaging device according to the first embodiment.

FIG. 4 is a cross-sectional view illustrating a configuration example of a pixel array unit provided in the solid-state imaging device according to the first embodiment.

FIG. 5 is a cross-sectional view illustrating a modification example of the pixel array unit provided in the solid-state imaging device according to the first embodiment.

FIG. 6 illustrates a configuration example of a signal reading circuit for each column according to the first embodiment.

FIG. 7 shows an example of a waveform of each unit during signal reading of the imaging device according to the first embodiment.

FIG. 8 illustrates circuit configuration examples of a voltage generation unit connected to a vertical signal line of the imaging device according to the first embodiment.

FIG. 9 is a block diagram showing a switching example during the capacitive load reading of a signal reading circuit for each column according to a second embodiment.

FIG. 10 is a block diagram showing a switching example during the constant-current reading of the signal reading circuit for each column according to the second embodiment.

FIG. 11 shows an example of a waveform of each unit during the constant-current reading of the signal reading circuit according to the second embodiment.

FIG. 12 illustrates a configuration example of a signal reading circuit for each column according to a third embodiment.

FIG. 13 illustrates a configuration example of a signal reading circuit for each column according to a fourth embodiment.

FIG. 14 illustrates a configuration example of a signal reading circuit for two columns according to a fifth embodiment.

FIG. 15 illustrates a configuration example of a signal reading circuit for four columns according to a sixth embodiment.

FIG. 16 illustrates a configuration example of a signal reading circuit for each column according to a seventh embodiment.

FIG. 17 shows an example of a waveform of each unit during signal reading of an imaging device according to the seventh embodiment.

FIG. 18 illustrates a configuration example of a signal reading circuit for each column according to an eighth embodiment.

FIG. 19 illustrates a configuration example of a signal reading circuit for each column according to a ninth embodiment.

FIG. 20 illustrates a configuration example of a signal reading circuit for each column according to a tenth embodiment.

FIG. 21 illustrates a configuration example of a signal reading circuit for two columns according to an eleventh embodiment.

FIG. 22 shows an example of a waveform of each unit during signal reading of an imaging device according to an eleventh embodiment.

FIG. 23 is a perspective view illustrating a configuration example of an imaging device according to a twelfth embodiment.

FIG. 24 is a block diagram illustrating a schematic configuration example of a vehicle control system.

FIG. 25 is an explanatory diagram illustrating an example of the installation positions of imaging units.

### DESCRIPTION OF EMBODIMENTS

Modes for carrying out the present technique (hereinafter referred to as embodiments) will be described below. The description will be given in the following order.
1. First embodiment (example of connection of diode-connected transistor via signal line transistor electrically connected to vertical signal line)
2. Second embodiment (example of switching of signal line transistor electrically connected to vertical signal line such that signal line transistor operates as constant-current transistor or signal-line transistor is connected to diode-connected transistor)
3. Third embodiment (example of parallel connection of constant-current transistor to series circuit of signal line transistor and diode-connected transistor)
4. Fourth embodiment (example of series transistor connected in series to signal line transistor electrically connected to vertical signal line such that series transistor is operated as diode-connected transistor or constant-current transistor)
5. Fifth embodiment (example of diode-connected transistor shared among multiple columns)
6. Sixth embodiment (example of diode-connected transistor with drain shared among multiple columns)
7. Seventh embodiment (example of changeable number of diode-connected transistors connected in series via signal line transistors electrically connected to vertical signal lines)
8. Eighth embodiment (example of provision of signal line transistor and diode-connected transistor on upper chip having pixel and provision of constant-current transistor on lower chip)
9. Ninth embodiment (example of application of capacitive load reading using series circuit of signal line transistor and diode-connected transistor to cell having amplification transistor shared among four photodiodes)
10. Tenth embodiment (example of application of capacitive load reading using series circuit of signal line transistor and diode-connected transistor to binning reading)
11. Eleventh embodiment (example of application of capacitive load reading using series circuit of signal line transistor and diode-connected transistor to edge detection)
12. Twelfth embodiment (example of lamination of substrate where solid-state imaging device is formed)
13. Example of application to mobile object

### 1. First Embodiment

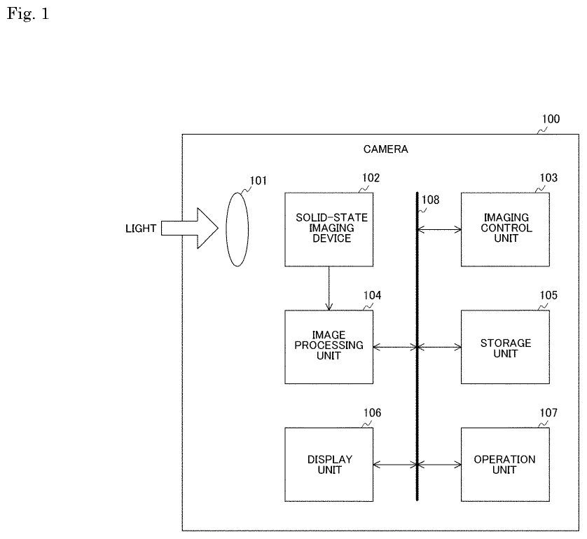

FIG. 1 is a block diagram illustrating a configuration example of a camera to which an imaging device according to a first embodiment is applied.

In FIG. 1, a camera 100 includes an optical system 101, a solid-state imaging device 102, an imaging control unit 103, an image processing unit 104, a storage unit 105, a display unit 106, and an operation unit 107. The imaging control unit 103, the image processing unit 104, the storage unit 105, the display unit 106, and the operation unit 107 are connected to one another via a bus 108. The camera 100 may be used as a stand-alone unit, may be incorporated into a mobile terminal such as a smartphone, or may be incorporated into an authentication device or a monitoring device.

The optical system 101 causes light from a subject to enter the solid-state imaging device 102 and forms a subject image on the light receiving surface of the solid-state imaging device 102. The optical system 101 can be provided with, for example, a focus lens, a zoom lens, and a diaphragm. The optical system 101 may be provided with a plurality of lenses such as a wide-angle lens, a standard lens, and a telephoto lens.

The solid-state imaging device 102 converts light from a subject into an electric signal for each pixel, digitizes the electric signal, and then outputs the signal. The solid-state imaging device 102 is, for example, a CMOS (Complementary Metal Oxide Semiconductor) image sensor or a CCD (Charge Coupled Device).

The imaging control unit 103 controls imaging by the solid-state imaging device 102 on the basis of a command from the operation unit 107. At this point, the imaging control unit 103 can control the exposure time, the exposure value, and the imaging timing of the solid-state imaging device 102.

The image processing unit 104 performs image processing on the basis of an output from the solid-state imaging device 102. The image processing is, for example, gamma correction, white balance processing, sharpness processing, and tone conversion processing. The image processing unit 104 may include a processor that performs processing on the basis of software.

The storage unit 105 stores images captured by the solid-state imaging device 102 and the imaging parameters and the like of the solid-state imaging device 102.

Furthermore, the storage unit 105 can store a program that operates the camera 100 on the basis of software. The storage unit 105 may include ROM (Read Only Memory), RAM (Random Access Memory), and a memory card.

The display unit 106 displays captured images or displays various type of information that supports an imaging operation. The display unit 106 may be a liquid crystal display or an organic EL (Electro Luminescence) display.

The operation unit 107 provides a user interface for operating the camera 100. The operation unit 107 may include, for example, a button, a dial, and a switch that are provided on the camera 100. The operation unit 107 may be configured as a touch panel with the display unit 106.

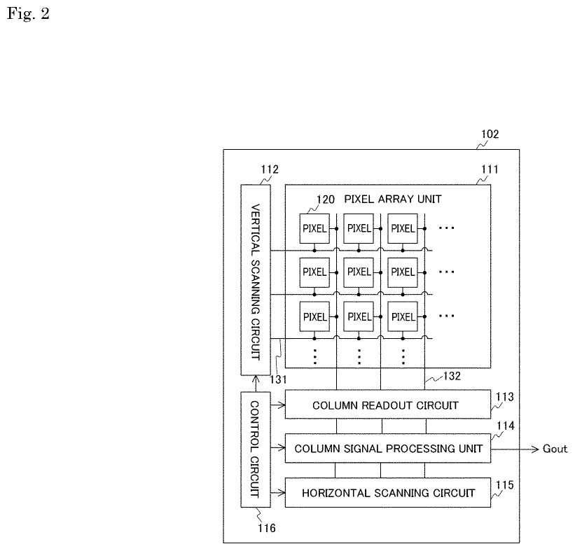

FIG. 2 is a block diagram illustrating a configuration example of a solid-state imaging device according to the first embodiment.

In FIG. 2, the solid-state imaging device 102 includes a pixel array unit 111, a vertical scanning circuit 112, a column readout circuit 113, a column signal processing unit 114, a horizontal scanning circuit 115, and a control circuit 116.

The pixel array unit 111 includes a plurality of pixels 120. The pixels 120 are arranged in a matrix form along the row direction (also referred to as the horizontal direction) and the column direction (also referred to as the vertical direction). The pixel 120 can configure a source follower between the pixel 120 and the column readout circuit 113 when a signal is read. The pixels 120 in each row are connected to a horizontal driving line 131, and the pixels 120 in each column are connected to a vertical signal line 132. The horizontal driving line 131 drives the pixels 120 for each row when a signal is read from the pixel 120. The vertical signal line 132 transmits a potential based on a charge accumulated according to a current passing when a signal from the pixel 120 is read, to the column signal processing unit 114 for each column. The vertical signal line 132 is an example of a signal line described in the claims.

The vertical scanning circuit 112 scans the pixels 120, which are to be read, in the column direction. The vertical scanning circuit 112 may be configured with a vertical register.

The column readout circuit 113 can configure a source follower between the column readout circuit 113 and the pixel 120 when a signal is read from the pixel 120. At this point, the column readout circuit 113 can change the potential of the vertical signal line 132 on the basis of a charge held in the pixel 120. The column readout circuit 113 can support capacitive load reading. The column readout circuit 113 may also support constant-current reading.

The column signal processing unit 114 processes signals transmitted from the pixels 120 in the column direction. For example, the column signal processing unit 114 can perform correlated double sampling (CDS: Correlated Double Sampling) on the basis of the signals transmitted from the pixels 120 in the column direction. Moreover, the column signal processing unit 114 can perform AD (Analog to Digital) conversion on the basis of the signals transmitted from the pixels 120 in the column direction and output an imaging signal Gout.

The horizontal scanning circuit 115 scans the pixels 120, which are to be read, in the row direction. The horizontal scanning circuit 115 may be configured with a horizontal register.

The control circuit 116 controls the vertical scanning circuit 112, the column readout circuit 113, the column signal processing unit 114, and the horizontal scanning circuit 115. For example, the control circuit 116 can control the scanning timing in the column direction, the scanning timing in the row direction, the operation timing of the column readout circuit 113, and the processing timing of the column signal processing unit 114.

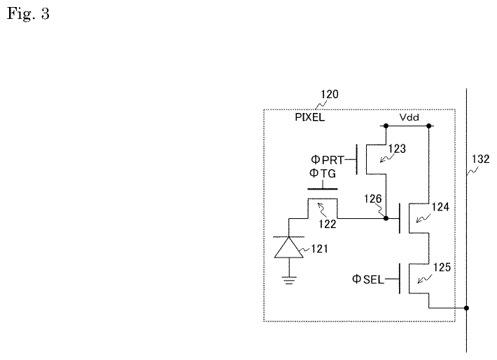

FIG. 3 is a block diagram illustrating a circuit configuration example of a pixel provided in the solid-state imaging device according to the first embodiment.

In FIG. 3, the pixel 120 includes a photodiode 121, a transfer transistor 122, a reset transistor 123, an amplification transistor 124, a selection transistor 125, and a floating diffusion 126. MOS (Metal Oxide Semiconductor) transistors can be used as the transfer transistor 122, the reset transistor 123, the amplification transistor 124, and the selection transistor 125.

The amplification transistor 124 and the selection transistor 125 are connected in series. The cathode of the photodiode 121 is connected to the floating diffusion 126 via the transfer transistor 122. Moreover, the floating diffusion 126 is connected to a power source Vdd via the reset transistor 123. The power source Vdd is connected to the vertical signal line 132 via the series circuit of the amplification transistor 124 and the selection transistor 125. The gate of the amplification transistor 124 is connected to the floating diffusion 126.

A transfer signal ΦTG is applied to the gate of the transfer transistor 122. A pixel reset signal ΦPRT is applied to the gate of the reset transistor 123. A selection signal ΦSEL is applied to the gate of the selection transistor 125. The transfer signal ΦTG, the pixel reset signal ΦPRT, and the selection signal ΦSEL can be transmitted to the pixels 120 via the horizontal driving lines 131 of FIG. 2.

When the transfer transistor 122 is turned on, charge accumulated in the photodiode 121 is transferred to the floating diffusion 126. Thereafter, when the selection transistor 125 is turned on, the source potential of the amplification transistor 124 changes according to the potential of the floating diffusion 126. The source potential of the amplification transistor 124 is then applied to the vertical signal line 132 via the selection transistor 125 and is transmitted via the vertical signal line 132. When the reset transistor 123 is turned on, charge accumulated in the floating diffusion 126 is discharged.

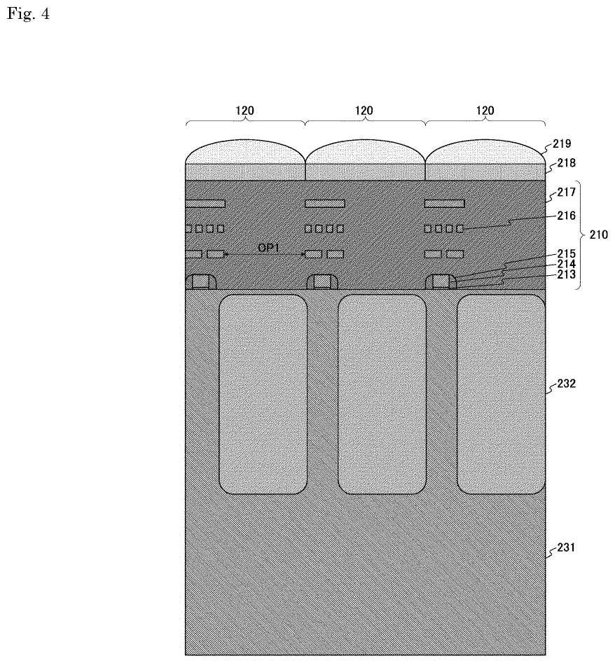

FIG. 4 is a cross-sectional view illustrating a configuration example of the pixel array unit provided in the solid-state imaging device according to the first embodiment. FIG. 4 illustrates an example of a front-illuminated solid-state imaging device. Moreover, FIG. 4 illustrates a configuration example of three pixels.

In FIG. 4, a photodiode 232 for each of the pixels 120 is formed in a semiconductor substrate 231. The semiconductor substrate 231 may be made of Si, InGaAs, or InP.

Gate electrodes 214 and a wiring layer 210 are formed on the semiconductor substrate 231. The gate electrode 214 is formed on the semiconductor substrate 231 with a gate insulating film 213 interposed therebetween. A sidewall 215 is formed on a side wall of the gate electrode 214. The gate electrode 214 may be made of, for example, polycrystalline silicon containing impurity. The gate insulating film 213 may be composed of, for example, a silicon oxide film. The sidewall 215 may be composed of, for example, a silicon oxide film or a silicon nitride film.

The gate electrode 214 can be used for pixel transistors. The pixel transistors include the transfer transistor 122, the reset transistor 123, the amplification transistor 124, and the selection transistor 125 of FIG. 3.

Wires 216 are formed above the gate electrode 214. FIG. 4 illustrates an example of three-layer wiring. At this point, the wires 216 have an opening OP1 that allows light to enter the photodiode 232. The gate electrodes 214 and the wires 216 are electrically isolated from each other with an insulating layer 217. The insulating layer 217 may be, for example, a silicon oxide film. The wires 216 may be made of, for example, a metal such as Al or Cu.

On the wiring layer 210, a color filter 218 is formed for each of the pixels 120. On the color filter 218, a micro lens 219 is formed for each of the pixels 120. The color filter 218 and the micro lens 219 may be made of, for example, transparent resin such as acrylic or polycarbonate. The color filter 218 may color with an added pigment. The color filter 218 may constitute, for example, a Bayer layout.

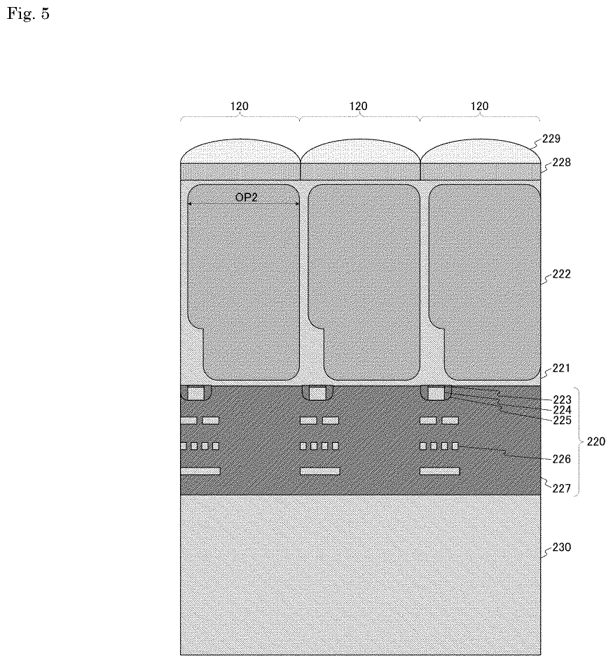

FIG. 5 is a cross-sectional view illustrating a modification example of the pixel array unit provided in the solid-state imaging device according to the first embodiment. FIG. 5 illustrates an example of a back-illuminated solid-state imaging device. Moreover, FIG. 5 illustrates a configuration example of three pixels.

In FIG. 5, a photodiode 222 for each of the pixels 120 is formed in a semiconductor layer 221. The semiconductor layer 221 may be made of Si, InGaAs, or InP. For example, the semiconductor layer 221 can be formed by reducing the thickness of a semiconductor substrate, which has the photodiodes 222 on the front side, from the back side.

On the semiconductor layer 221, gate electrodes 224 and a wiring layer 220 are formed. The gate electrode 224 is formed on the semiconductor layer 221 with a gate insulating film 223 interposed therebetween. A sidewall 225 is formed on a side wall of the gate electrode 224.

The gate electrode 224 can be used for pixel transistors. The pixel transistors include the transfer transistor 122, the reset transistor 123, the amplification transistor 124, and the selection transistor 125 of FIG. 3.

Wires 226 are formed above the gate electrode 224. FIG. 5 illustrates an example of three-layer wiring. The gate electrodes 224 and the wires 226 are electrically isolated from each other with an insulating layer 227. The semiconductor layer 221 is supported on a support substrate 230 with the insulating layer 227 interposed therebetween. The support substrate 230 may be a glass substrate, a Si substrate, or a sapphire substrate.

On the back side of the semiconductor layer 221, a color filter 228 is formed for each of the pixels 120. On the color filter 228, a micro lens 229 is formed for each of the pixels 120. The color filter 228 may constitute, for example, a Bayer layout.

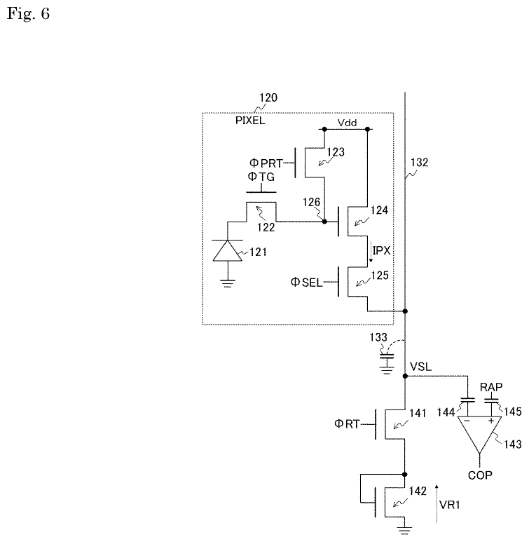

FIG. 6 illustrates a configuration example of a signal reading circuit for each column according to the first embodiment.

In FIG. 6, the amplification transistor 124 is connected to the vertical signal line 132 via the selection transistor 125. Moreover, a capacitor 133 is added to the vertical signal line 132. The capacitor 133 may be a parasitic capacitance of the vertical signal line 132 or a capacitive element connected to the vertical signal line 132.

Furthermore, a signal line transistor 141 is electrically connected to the vertical signal line 132. The signal line transistor 141 can reset a potential VSL of the vertical signal line 132. The signal line transistor 141 may be, for example, a MOS transistor. A signal-line reset signal ΦRT is applied to the gate of the signal line transistor 141.

A diode-connected transistor 142 is connected in series to the signal line transistor 141. The diode-connected transistor 142 may be, for example, a MOS transistor. At this point, the gate of the diode-connected transistor 142 is connected to the drain of the diode-connected transistor 142. The source of the diode-connected transistor 142 is grounded. The source of the diode-connected transistor 142 may be connected to a potential higher than the ground potential. The diode-connected transistor 142 can generate a voltage (e.g., 0.5 V) higher than 0 V and set the potential VSL of the vertical signal line 132 at a potential higher than 0 V through the signal line transistor 141. The diode-connected transistor 142 is an example of a voltage generation unit described in the claims.

The vertical signal line 132 is connected to the inverting input of a comparator 143 via a DC-cut capacitor 144. At this point, the potential VSL of the vertical signal line 132 is applied to the inverting input of the comparator 143 via the DC-cut capacitor 144. A reference signal RAP is input to the non-inverting input of the comparator 143 via a DC-cut capacitor 145. The reference signal RAP is, for example, a ramp signal.

In this configuration, the signal line transistor 141 is turned on before a signal from the pixel 120 is read, so that the potential VSL of the vertical signal line 132 is set at a potential higher than 0 V. The selection transistor 125 is then turned on after the signal line transistor 141 is turned off, so that a signal is read from the pixel 120 and a pixel current IPX passes through the vertical signal line 132 via the selection transistor 125. At this point, a charge corresponding to the pixel current IPX is accumulated in the capacitor 133, and the potential VSL of the vertical signal line 132 changes on the basis of the charge accumulated in the capacitor 133. Thereafter, in the comparator 143, the potential VSL of the vertical signal line 132 is compared with the reference signal RAP, and a comparison result COP is output.

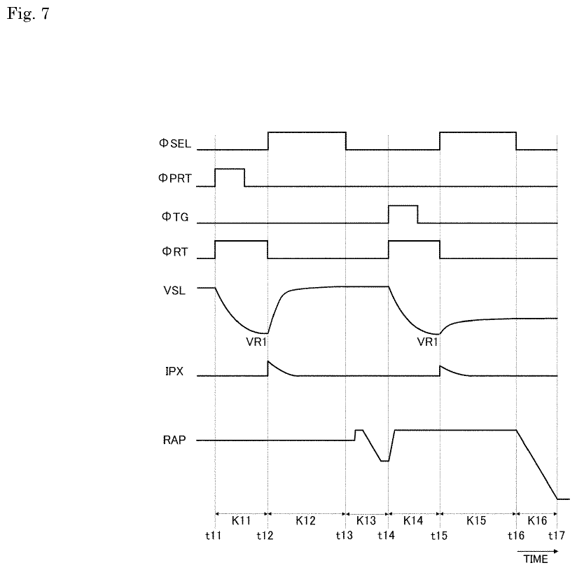

FIG. 7 shows an example of a waveform of each unit during signal reading of the imaging device according to the first embodiment.

In FIG. 7, a pixel reset/VSL reset is performed in capacitive load reading (K11). At this point, the pixel reset signal ΦPRT rises (t11), and the reset transistor 123 is turned on to reset the floating diffusion 126. Moreover, the reset level of the floating diffusion 126 can be set at a power source potential Vdd. Furthermore, the signal-line reset signal ΦRT rises (t11), and the signal line transistor 141 is turned on to reset the vertical signal line 132. At this point, when the signal line transistor 141 is turned on, current passes through the diode-connected transistor 142 via the signal line transistor 141. Thus, the reset level of the vertical signal line 132 is set at a potential (e.g., 0.5 V) higher than 0 V by a forward voltage VR1 of the diode-connected transistor 142. The pixel reset signal ΦPRT and the signal-line reset signal ΦRT do not always need to rise at the same time and may rise at different times. Moreover, the signal-line reset signal ΦRT does not always need to fall after the pixel reset signal ΦPRT. The timing of falling is not particularly limited before the selection signal ΦSEL rises.

Subsequently, P-phase VSL settling is performed (K12). At this point, the signal-line reset signal ΦRT falls, the selection signal ΦSEL rises (t12), and the selection transistor 125 is turned on. Thereafter, on the basis of the source follower operation of the amplification transistor 124, the pixel current IPX corresponding to the reset level of the floating diffusion 126 passes through the vertical signal line 132 via the selection transistor 125. A charge corresponding to the pixel current IPX is then accumulated in the capacitor 133, and the potential VSL of the vertical signal line 132 is set on the basis of the charge accumulated in the capacitor 133.

Subsequently, P-phase AD is performed (K13). At this point, the selection signal ΦSEL falls (t13), and then a ramp signal is supplied as the reference signal RAP to the comparator 143. Thereafter, in the comparator 143, the potential VSL of the vertical signal line 132 is compared with the reference signal RAP, the potential VSL corresponding to the reset level. The time when the level of the reference signal RAP agrees with the potential VSL of the vertical signal line 132 is output as the comparison result COP. At this point, the reset level read from the pixel 120 undergoes AD conversion on the basis of a counting operation until the level of the reference signal RAP agrees with the potential VSL of the vertical signal line 132.

Subsequently, a transfer/VSL reset is performed (K14). At this point, the transfer signal ΦTG rises (t14), and the transfer transistor 122 is turned on to transfer charge accumulated in the photodiode 121 to the floating diffusion 126. Moreover, the signal-line reset signal ΦRT rises (t14), and the signal line transistor 141 is turned on to reset the vertical signal line 132. At this point, when the signal line transistor 141 is turned on, current passes through the diode-connected transistor 142 via the signal line transistor 141. Thus, the reset level of the vertical signal line 132 is set at a potential (e.g., 0.5 V) higher than 0 V by the forward voltage VR1 of the diode-connected transistor 142. The transfer signal ΦTG and the signal-line reset signal ΦRT do not always need to rise at the same time and may rise at different times. Moreover, the signal-line reset signal ΦRT does not always need to fall after the transfer signal ΦTG. The timing of falling is not particularly limited before the selection signal ΦSEL rises.

Subsequently, D-phase VSL settling is performed (K15). At this point, the signal-line reset signal ΦRT falls, the selection signal ΦSEL rises (t15), and the selection transistor 125 is turned on. Thereafter, on the basis of the source follower operation of the amplification transistor 124, the pixel current IPX corresponding to the signal level of the floating diffusion 126 passes through the vertical signal line 132 via the selection transistor 125. A charge corresponding to the pixel current IPX is then accumulated in the capacitor 133, and the potential VSL of the vertical signal line 132 is set on the basis of the charge accumulated in the capacitor 133.

Subsequently, D-phase AD is performed (K16). At this point, the selection signal ΦSEL falls (t16), and then a ramp signal is supplied as the reference signal RAP to the comparator 143 (t16 to t17). Thereafter, in the comparator 143, the potential VSL of the vertical signal line 132 is compared with the reference signal RAP, the potential VSL corresponding to the signal level. The time when the level of the reference signal RAP agrees with the potential VSL of the vertical signal line 132 is output as the comparison result COP. At this point, the signal level read from the pixel 120 undergoes AD conversion on the basis of a counting operation until the level of the reference signal RAP reaches the potential VSL of the vertical signal line 132.

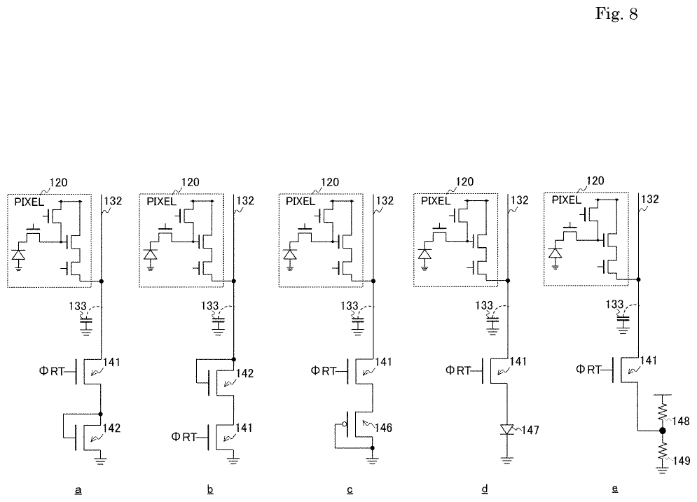

FIG. 8 illustrates circuit configuration examples of the voltage generation unit connected to the vertical signal line of the imaging device according to the first embodiment.

In a of FIG. 8, the voltage generation unit connected to the vertical signal line 132 may include the signal line transistor 141 and the diode-connected transistor 142. At this point, the diode-connected transistor 142 may be an NMOS transistor. Moreover, the signal line transistor 141 may be connected to the drain side of the diode-connected transistor 142.

In b of FIG. 8, the voltage generation unit connected to the vertical signal line 132 may include the signal line transistor 141 and the diode-connected transistor 142. At this point, the signal line transistor 141 may be connected to the source side of the diode-connected transistor 142.

In c of FIG. 8, the voltage generation unit connected to the vertical signal line 132 may include the signal line transistor 141 and a diode-connected transistor 146. At this point, the diode-connected transistor 146 may be a PMOS transistor. Moreover, the signal line transistor 141 may be connected to the drain side of the diode-connected transistor 146, or the signal line transistor 141 may be connected to the source side of the diode-connected transistor 146.

In d of FIG. 8, the voltage generation unit connected to the vertical signal line 132 may include the signal line transistor 141 and a PN junction diode 147. At this point, the signal line transistor 141 may be connected to the anode side of the PN junction diode 147, or the signal line transistor 141 may be connected to the cathode side of the PN junction diode 147.

In e of FIG. 8, the voltage generation unit connected to the vertical signal line 132 may include the signal line transistor 141 and voltage divider resistors 148 and 149. The voltage divider resistors 148 and 149 are connected in series. Furthermore, the source of the signal line transistor 141 is connected to the junction point of the voltage divider resistors 148 and 149. In the configuration, the resistance values of the voltage divider resistors 148 and 149 may be increased to reduce a current passing through the voltage divider resistors 148 and 149.

As described above, in the first embodiment, the vertical signal line 132 is reset when a signal from the pixel 120 is read, so that a charge corresponding to the pixel current IPX can be accumulated in the capacitor 133, the pixel current IPX passing when the signal is read from the pixel 120. Thus, a constant current corresponding to the signal read from the pixel 120 does not need to be passed through the vertical signal line 132 in order to detect the signal read from the pixel 120, thereby reducing current consumption when the signal is read from the pixel 120.

Moreover, the diode-connected transistor 142 is connected in series to the signal line transistor 141, so that the potential of the vertical signal line 132 can be raised according to the forward voltage VR1 of the diode-connected transistor 142 during the reset of the vertical signal line 132. Thus, the potential of the vertical signal line 132 can be set higher than 0 V at the start of the P-phase VSL settling, thereby shortening the settling time.

### 2. Second Embodiment

In the first embodiment, the diode-connected transistor 142 is connected via the signal line transistor 141 electrically connected to the vertical signal line 132. In a second embodiment, a signal line transistor 141 electrically connected to a vertical signal line 132 is switched to operate as a constant-current transistor or is switched to be connected to a diode-connected transistor 142.

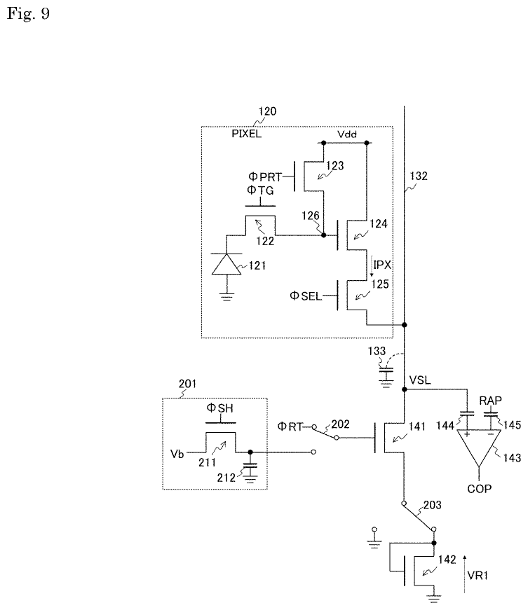

FIG. 9 is a block diagram showing a switching example during the capacitive load reading of the signal reading circuit for each column according to the second embodiment.

In FIG. 9, the signal reading circuit is configured such that a sample hold circuit 201 and switches 202 and 203 are added to the signal reading circuit of the first embodiment. The other configurations of the signal reading circuit of the second embodiment are identical to the configuration of the signal reading circuit of the first embodiment.

The sample hold circuit 201 samples and holds a bias voltage Vb, which allows the signal line transistor 141 to operate as a constant-current transistor, and applies the voltage to the gate of the signal line transistor 141. The sample hold circuit 201 includes a transistor 211 and a capacitor 212. The transistor 211 may be a MOS transistor. A sample hold signal ΦSH is applied to the gate of the transistor 211. The capacitor 212 is connected between the source of the transistor 211 and the ground potential.

The switch 202 switches the gate input of the signal line transistor 141 between a signal-line reset signal ΦRT and the output of the sample hold circuit 201. The switch 203 switches the connection of the signal line transistor 141 between the ground potential and the diode-connected transistor 142.

In this configuration, the switch 202 switches the gate input of the signal line transistor 141 to the signal-line reset signal ΦRT in capacitive load reading. The switch 203 switches the connection of the signal line transistor 141 to the diode-connected transistor 142. At this point, the operation of a signal reading circuit is identical to that of FIG. 7.

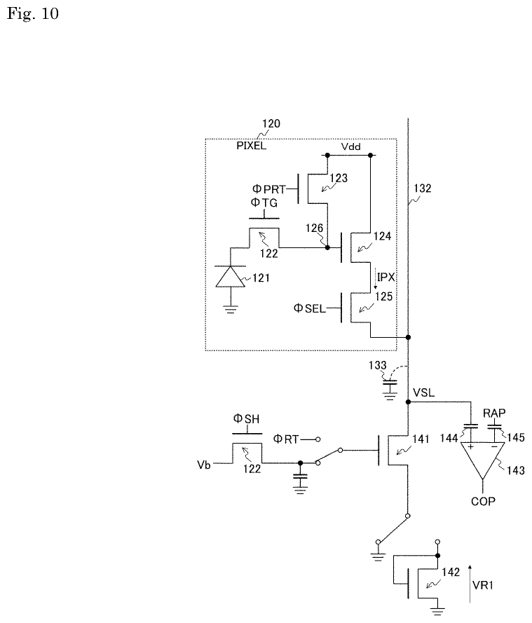

FIG. 10 is a block diagram showing a switching example during the constant-current reading of the signal reading circuit for each column according to the second embodiment.

In FIG. 10, in the constant current reading, the switch 202 switches the gate input of the signal line transistor 141 to the output of the sample hold circuit 201. At this point, the bias voltage Vb is set to turn on the signal line transistor 141. The switch 203 switches the connection of the signal line transistor 141 to the ground potential.

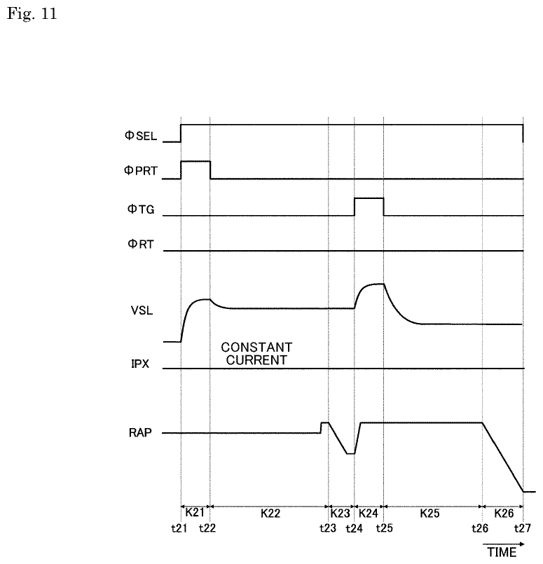

FIG. 11 shows an example of a waveform of each unit during the constant-current reading of the signal reading circuit according to the second embodiment.

In FIG. 11, in order to prevent horizontal noise during AD conversion in the constant current reading, the transistor 211 is turned on to sample and hold the bias voltage Vb. Thereafter, the transistor 211 is turned off, and the bias voltage Vb that is sampled and held by the sample hold circuit 201 is applied to the gate of the signal line transistor 141, allowing the signal line transistor 141 to operate as a constant-current transistor.

Subsequently, a pixel reset is performed (K21). At this point, a pixel reset signal ΦPRT rises (t21), and a reset transistor 123 is turned on to reset a floating diffusion 126. Furthermore, a selection signal ΦSEL rises (t21), and a selection transistor 125 is turned on. At this point, a potential VSL of the vertical signal line 132 is set on the basis of a source follower operation performed when a power source potential Vdd is applied to the gate of an amplification transistor 124.

Subsequently, P-phase VSL settling is performed (K22). At this point, the pixel reset signal ΦPRT falls (t22) and the reset transistor 123 is turned off. The potential VSL of the vertical signal line 132 is then set on the basis of a source follower operation performed when the reset level of the floating diffusion 126 is applied to the gate of the amplification transistor 124.

Thereafter, P-phase AD is performed (K23). At this point, a ramp signal is supplied as a reference signal RAP to a comparator 143. Thereafter, in the comparator 143, the potential VSL of the vertical signal line 132 is compared with the reference signal RAP, the potential VSL corresponding to the reset level. The time when the level of the reference signal RAP agrees with the potential VSL of the vertical signal line 132 is output as a comparison result COP. At this point, the reset level read from the pixel 120 undergoes AD conversion on the basis of a counting operation until the level of the reference signal RAP agrees with the potential VSL of the vertical signal line 132.

Subsequently, transfer is performed (K24). At this point, a transfer signal ΦTG rises (t24), and a transfer transistor 122 is turned on to transfer charge accumulated in a photodiode 121 to the floating diffusion 126. Moreover, the potential VSL of the vertical signal line 132 is set on the basis of a source follower operation performed when the cathode potential of the photodiode 121 is applied to the gate of the amplification transistor 124.

Subsequently, D-phase VSL settling is performed (K25). At this point, the transfer signal ΦTG falls (t25) and the transfer transistor 122 is turned off. The potential VSL of the vertical signal line 132 is then set on the basis of a source follower operation performed when the signal level of the floating diffusion 126 is applied to the gate of the amplification transistor 124.

Subsequently, P-phase AD is performed (K26). At this point, the ramp signal is supplied as the reference signal RAP to the comparator 143 (t26 to t27). Thereafter, in the comparator 143, the potential VSL of the vertical signal line 132 is compared with the reference signal RAP, the potential VSL corresponding to the signal level. The time when the level of the reference signal RAP agrees with the potential VSL of the vertical signal line 132 is output as the comparison result COP. At this point, the signal level read from the pixel 120 undergoes AD conversion on the basis of a counting operation until the level of the reference signal RAP reaches the potential VSL of the vertical signal line 132.

As described in the second embodiment, the signal line transistor 141 can be used to reset the vertical signal line 132, or the signal line transistor 141 can be used as a constant-current transistor. This enables switching between capacitive load reading and constant current reading, so that the imaging device can be operated with low power consumption or at high speeds according to the use pattern of the imaging device.

### 3. Third Embodiment

In the second embodiment, constant current reading and capacitive load reading can be switched on the basis of the switching operations of the switches 202 and 203. In a third embodiment, in order to switch constant-current reading and capacitive load reading, a constant current transistor is connected in parallel with the series circuit of a signal line transistor 141 and a diode-connected transistor 142.

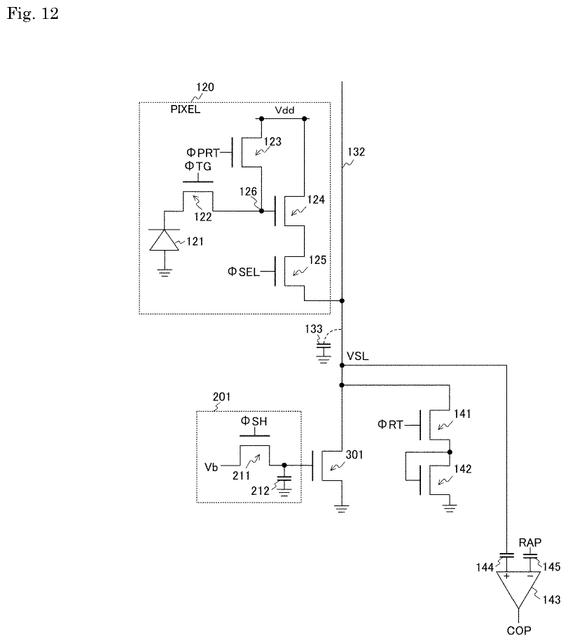

FIG. 12 illustrates a configuration example of a signal reading circuit for each column according to the third embodiment.

In FIG. 12, the signal reading circuit is configured such that a sample hold circuit 201 and a constant-current transistor 301 are added to the signal reading circuit of the first embodiment. The other configurations of the signal reading circuit of the third embodiment are identical to the configuration of the signal reading circuit of the first embodiment.

The constant-current transistor 301 is electrically connected to a vertical signal line 132. The constant-current transistor 301 may be a MOS transistor. The output of the sample hold circuit 201 is connected to the gate of the constant-current transistor 301.

In capacitive load reading of this configuration, a bias voltage Vb is set at 0 V and a sample hold signal ΦSH is set at a high level. In this case, the constant-current transistor 301 is turned off, so that current does not pass through the constant-current transistor 301. At this point, the operation of the signal reading circuit is identical to that of FIG. 7.

In constant-current reading, the transistor 211 is turned on to sample and hold the bias voltage Vb. Thereafter, a transistor 211 is turned off, and the bias voltage Vb sampled and held by the sample hold circuit 201 is applied to the gate of the constant-current transistor 301. In this case, the constant-current transistor 301 is turned on, so that constant current passes through the constant-current transistor 301. At this point, the operation of the signal reading circuit is identical to that of FIG. 11.

As described above, in the third embodiment, the constant-current transistor 301 is connected in parallel with the series circuit of the signal line transistor 141 and the diode-connected transistor 142. This enables switching between constant-current reading and capacitive load reading without providing switches 202 and 203 and achieves a shorter settling time during capacitive load reading.

### 4. Fourth Embodiment

In the third embodiment, in order to switch constant-current reading and capacitive load reading, the constant-current transistor 301 is connected in parallel with the series circuit of the signal line transistor 141 and the diode-connected transistor 142. In a fourth embodiment, in order to switch constant-current reading and capacitive load reading, a switching transistor is connected between the gate and drain of a series transistor connected in series to a signal line transistor 141 that is electrically connected to a vertical signal line 132.

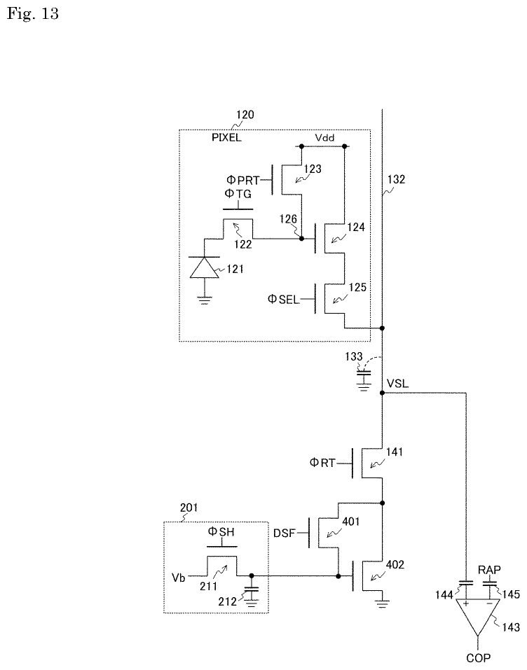

FIG. 13 illustrates a configuration example of a signal reading circuit for each column according to the fourth embodiment.

In FIG. 13, the signal reading circuit includes a series transistor 402 instead of the diode-connected transistor 142 of the first embodiment. Moreover, in the signal reading circuit, a sample hold circuit 201 and a switching transistor 401 are added to the signal reading circuit of the first embodiment. The other configurations of the signal reading circuit of the fourth embodiment are identical to the configuration of the signal reading circuit of the first embodiment.

The series transistor 402 is connected in series to the signal line transistor 141. The switching transistor 401 is connected between the gate and drain of the series transistor 402. A switching signal DSF is applied to the gate of the switching transistor 401. The series transistor 402 and the switching transistor 401 may be MOS transistors.

In capacitive load reading of this configuration, the switching signal DSF is set at a high level and the switching transistor 401 is turned on. At this point, the gate and drain of the series transistor 402 are short-circuited and the series transistor 402 operates as a diode-connected transistor. A sample hold signal ΦSH is set at a low level, and a transistor 211 is turned off. At this point, the operation of the signal reading circuit is identical to that of FIG. 7.

In constant-current reading, the switching signal DSF is set at the low level, and the switching transistor 401 is turned off. Moreover, the transistor 211 is turned on to sample and hold a bias voltage Vb. Thereafter, the transistor 211 is turned off, and the bias voltage Vb sampled and held by the sample hold circuit 201 is applied to the gate of the series transistor 402. In this case, the series transistor 402 is turned on, so that constant current passes through the series transistor 402. At this point, the operation of the signal reading circuit is identical to that of FIG. 11.

As described above, in the fourth embodiment, the series transistor 402 is connected in series to the signal line transistor 141, and the switching transistor 401 is connected between the gate and drain of the series transistor 402. This enables switching between constant-current reading and capacitive load reading without providing switches 202 and 203 and achieves a shorter settling time during capacitive load reading.

### 5. Fifth Embodiment

In the first embodiment, the diode-connected transistor 142 is provided for each column. In the fifth embodiment, a diode-connected transistor 142 is shared among a plurality of columns.

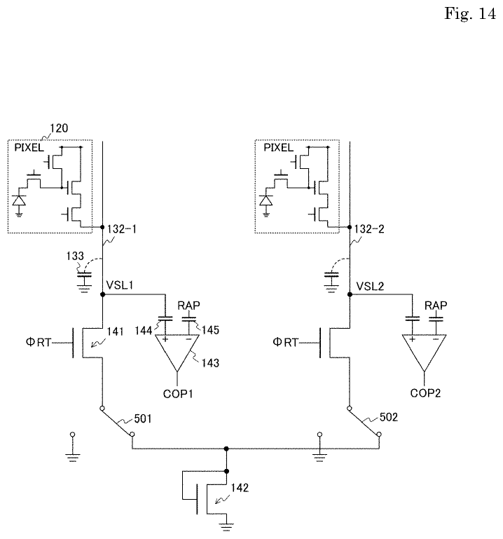

FIG. 14 illustrates a configuration example of a signal reading circuit for two columns according to the fifth embodiment.

In FIG. 14, the signal reading circuit includes multiple vertical signal lines 132-1 and 132-2, and switches 501 and 502 are added to the signal reading circuit of the first embodiment. The other configurations of the signal reading circuit of the fifth embodiment are identical to the configuration of the signal reading circuit of the first embodiment.

A pixel 120 is connected to each of the vertical signal lines 132-1 and 132-2, and a comparator 143 is provided for each of the vertical signal lines 132-1 and 132-2. Moreover, a signal line transistor 141 is connected to each of the vertical signal lines 132-1 and 132-2, and the switches 501 and 502 are provided for the vertical signal lines 132-1 and 132-2, respectively.

The switch 501 switches the connection of a signal line transistor 141, which is connected to the vertical signal line 132-1, between the ground potential and the diode-connected transistor 142. The switch 502 switches the connection of a signal line transistor 141, which is connected to the vertical signal line 132-2, between the ground potential and the diode-connected transistor 142. In this configuration, the connection of the signal line transistor 141 connected to each of the vertical signal lines 132-1 and 132-2 is switched to the diode-connected transistor 142, so that the diode-connected transistor 142 can be shared among the plurality of columns.

At this point, in the comparator 143 connected to the vertical signal line 132-1, a potential VSL1 of the vertical signal line 132-1 is compared with a reference signal RAP, and a comparison result COP1 is output. In the comparator 143 connected to the vertical signal line 132-2, a potential VSL2 of the vertical signal line 132-2 is compared with the reference signal RAP, and a comparison result COP2 is output.

As described above, in the fifth embodiment, the diode-connected transistor 142 is shared among the plurality of columns. This can increase the number of columns while suppressing an increase in the number of diode-connected transistors 142.

### 6. Sixth Embodiment

In the first embodiment, the reset level of the vertical signal line 132 is set for each column. In a sixth embodiment, the reset level of a vertical signal line 132 is set in common for a plurality of columns.

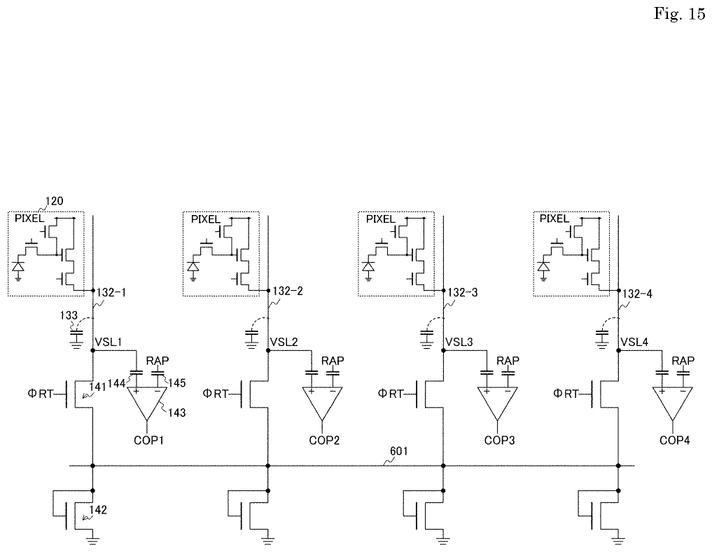

FIG. 15 illustrates a configuration example of a signal reading circuit for four columns according to the sixth embodiment.

In FIG. 15, the signal reading circuit includes multiple vertical signal lines 132-1 to 132-4, and a short-circuit line 601 is added to the signal reading circuit of the first embodiment. The other configurations of the signal reading circuit of the sixth embodiment are identical to the configuration of the signal reading circuit of the first embodiment.

A pixel 120 is connected to each of the vertical signal lines 132-1 to 132-4, and a comparator 143 is provided for each of the vertical signal lines 132-1 to 132-4. Moreover, a diode-connected transistor 142 is connected to each of the vertical signal lines 132-1 to 132-4 via a signal line transistor 141. The drains of the diode-connected transistors 142 provided for the respective vertical signal lines 132-1 to 132-4 are connected to one another via the short-circuit line 601.

At this point, in the comparator 143 connected to the vertical signal line 132-1, a potential VSL1 of the vertical signal line 132-1 is compared with a reference signal RAP, and a comparison result COP1 is output. In the comparator 143 connected to the vertical signal line 132-2, a potential VSL2 of the vertical signal line 132-2 is compared with the reference signal RAP, and a comparison result COP2 is output. In the comparator 143 connected to the vertical signal line 132-3, a potential VSL3 of the vertical signal line 132-3 is compared with the reference signal RAP, and a comparison result COP3 is output. In the comparator 143 connected to the vertical signal line 132-4, a potential VSL4 of the vertical signal line 132-4 is compared with the reference signal RAP, and a comparison result COP4 is output.

As described above, in the sixth embodiment, the drains of the diode-connected transistors 142 of different columns are connected to one another via the short-circuit line 601. This can perform capacitive load reading for each column while reducing variations in the reset level of the vertical signal line 132 among columns.

### 7. Seventh Embodiment

In the first embodiment, the reset level of the vertical signal line 132 is fixed at a certain value in P-phase VSL settling and D-phase VSL settling. In the seventh embodiment, the reset level of a vertical signal line 132 can be switched between P-phase VSL settling and D-phase VSL settling.

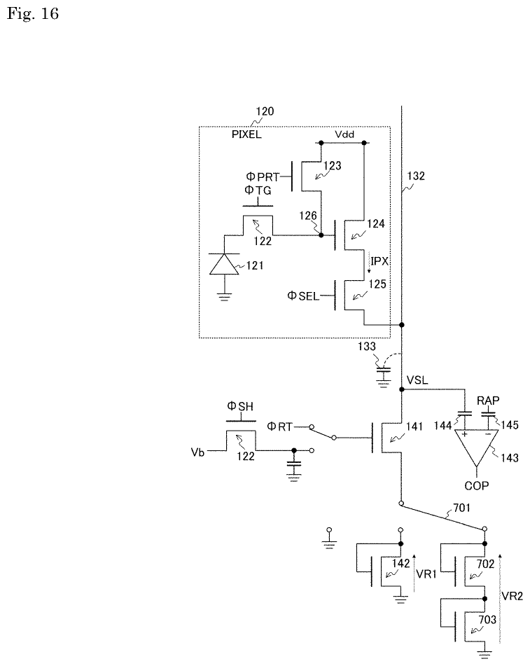

FIG. 16 illustrates a configuration example of a signal reading circuit for each column according to the seventh embodiment.

In FIG. 16, the signal reading circuit is configured such that a switch 701 and diode-connected transistors 702 and 703 are added to the signal reading circuit of the first embodiment. The other configurations of the signal reading circuit of the seventh embodiment are identical to the configuration of the signal reading circuit of the first embodiment.

The diode-connected transistors 702 and 703 are connected in series. The switch 701 switches the connection of a signal line transistor 141 between a diode-connected transistor 142 and the series circuit of the diode-connected transistors 702 and 703.

At this point, when the signal line transistor 141 is connected to the diode-connected transistor 142, the reset level of the vertical signal line 132 can be raised according to a forward voltage VR1 of the diode-connected transistor 142. When the signal line transistor 141 is connected to the series circuit of the diode-connected transistors 702 and 703, the reset level of the vertical signal line 132 can be raised according to a forward voltage sum VR2 of the diode-connected transistors 702 and 703.

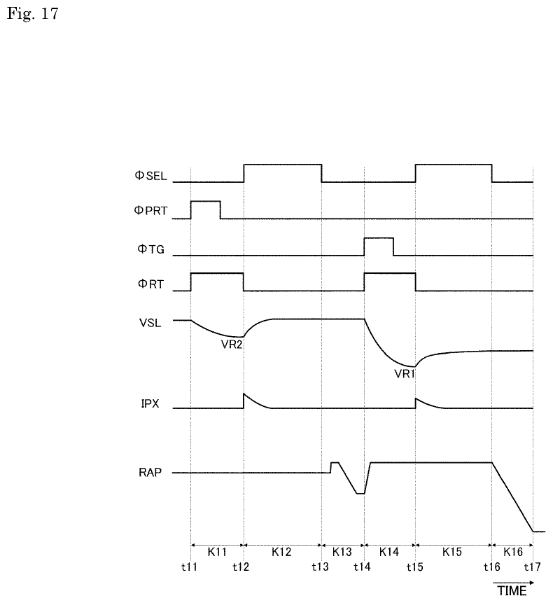

FIG. 17 shows an example of a waveform of each unit during signal reading of an imaging device according to the seventh embodiment.

A capacitive load reading operation in FIG. 17 is performed as in FIG. 7. However, in pixel reset/VSL reset (K11) before P-phase AD (K13), the signal line transistor 141 is connected to the series circuit of the diode-connected transistors 702 and 703. At this point, the reset level of the vertical signal line 132 is set at the forward voltage sum VR2 of the diode-connected transistors 702 and 703. In transfer/VSL reset (K14) before D-phase AD (K16), the signal line transistor 141 is connected to the diode-connected transistor 142. At this point, the reset level of the vertical signal line 132 is set at the forward voltage VR1 of the diode-connected transistor 142.

As described above, in the seventh embodiment, the reset level of the vertical signal line 132 in P-phase VSL settling is set higher than the reset level of the vertical signal line 132 in D-phase VSL settling. This can shorten a settling time before P-phase AD (K13) in capacitive load reading. Moreover, a potential VSL of the vertical signal line 132 of the vertical signal line 132 can be clipped by the forward voltage sum VR2 of the diode-connected transistors 702 and 703 when the amount of incident light is large. This can prevent a sunspot phenomenon.

In the seventh embodiment, in order to switch the reset level of the vertical signal line 132, the series circuit of the diode-connected transistors 702 and 703 is provided in addition to the diode-connected transistor 142. The series circuit of three or more diode-connected transistors may be provided to switch the reset level of the vertical signal line 132. Moreover, the configuration that allows switching of the reset level of the vertical signal line 132 is applicable to any one of the configurations of the second to sixth embodiments.

### 8. Eighth Embodiment

In the first embodiment, the diode-connected transistor 142 is connected via the signal line transistor 141 electrically connected to the vertical signal line 132 that transmits the signal read from the pixel 120. In an eighth embodiment, a signal line transistor 141 and a diode-connected transistor 142 are provided on an upper chip having a pixel 120, and a constant-current transistor 301 is provided on a lower chip.

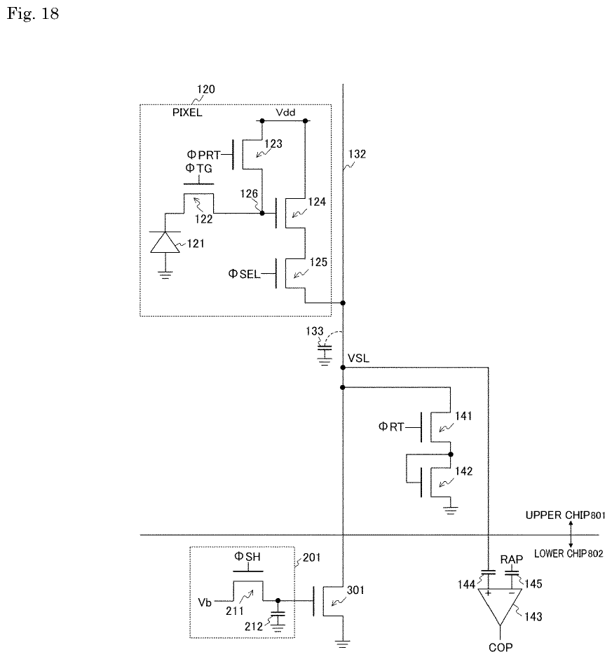

FIG. 18 illustrates a configuration example of a signal reading circuit for each column according to the eighth embodiment.

In FIG. 18, the circuit configuration of the signal reading circuit is identical to the circuit configuration of the signal reading circuit of FIG. 12. However, the signal reading circuit is formed on a laminated chip. The laminated chip includes an upper chip 801 and a lower chip 802. The upper chip 801 is stacked on the lower chip 802.

On the upper chip 801, the pixel 120, a vertical signal line 132, the signal line transistor 141, and the diode-connected transistor 142 are formed. At this point, the size and threshold value of the signal line transistor 141 can be set like the size and threshold value of a selection transistor 125. The size and threshold value of the diode-connected transistor 142 can be set like the size and threshold value of a reset transistor 123.

On the lower chip 802, a sample hold circuit 201, a constant-current transistor 301, and a comparator 143 are formed. At this point the vertical signal line 132 can be routed from the upper chip 801 to the lower chip 802.

As described above, in the eighth embodiment, the signal line transistor 141 and the diode-connected transistor 142 are formed on the upper chip 801 having the pixel 120. This can equalize variations in the characteristics of pixel transistors provided in the pixel 120 and variations in the characteristics of the signal line transistor 141 and the diode-connected transistor 142. Moreover, the configuration in which the signal reading circuit is formed on the laminated chip is applicable to any one of the configurations of the second to seventh embodiments.

### 9. Ninth Embodiment

In the first embodiment, capacitive load reading is applied to the pixel 120 in which the single photodiode 121 is provided for the single amplification transistor 124. In a ninth embodiment, capacitive load reading is applied to a cell in which four photodiodes are provided for the single amplification transistor 124.

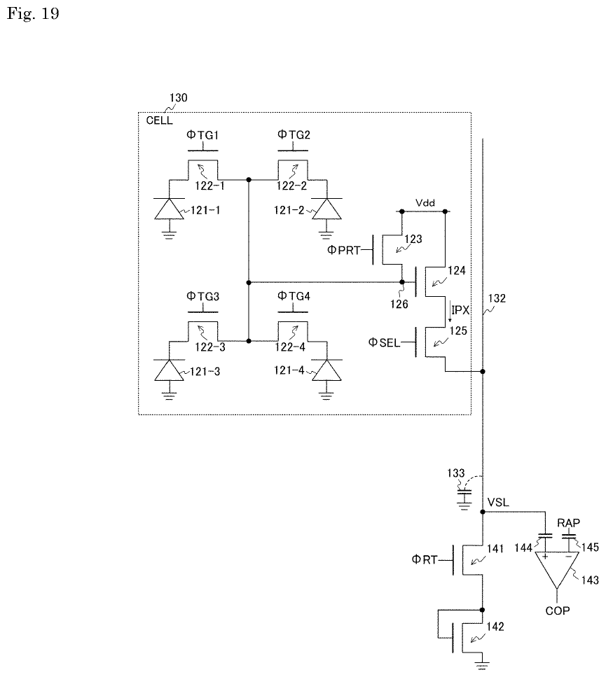

FIG. 19 Illustrates a Configuration Example of a Signal Reading Circuit for Each column according to the ninth embodiment.

In FIG. 19, the signal reading circuit includes a cell 130 instead of the pixel 120 of the signal reading circuit according to the first embodiment. The other configurations of the signal reading circuit of the ninth embodiment are identical to the configuration of the signal reading circuit of the first embodiment.

A cell 130 includes photodiodes 121-1 to 121-4 and transfer transistors 122-1 to 122-4 instead of the photodiode 121 and the transfer transistor 122 of the first embodiment. The other configurations of the cell 130 of the ninth embodiment are identical to the configuration of the pixel 120 of the first embodiment.

The photodiodes 121-1 to 121-4 can be arranged in two rows and two columns. The photodiodes 121-1 to 121-4 are connected to a floating diffusion 126 via the transfer transistors 122-1 to 122-4, respectively. Transfer signals ΦTG1 to ΦTG4 are applied to the gates of the transfer transistors 122-1 to 122-4. By controlling the timing of application of the transfer signals ΦTG1 to ΦTG4, signals can be read from the respective photodiodes 121-1 to 121-4 to a vertical signal line 132. A capacitive load reading operation from the photodiodes 121-1 to 121-4 is identical to that of FIG. 7.

As described above, in the ninth embodiment, the four photodiodes are shared by the single amplification transistor 124. This can increase the number of pixels while suppressing an increase in pixel regions, and apply capacitive load reading to each pixel.

In the example of the ninth embodiment, the four photodiodes 121-1 to 121-4 are shared by the single amplification transistor 124. Eight photodiodes may be shared by the single amplification transistor 124. Moreover, any one of the configurations of the second to eighth embodiments may be applied to the configuration including the cell 130.

### 10. Tenth Embodiment

In the first embodiment, capacitive load reading is applied to signal reading from the individual pixels 120 connected to the vertical signal line 132. In a tenth embodiment, capacitive load reading is applied to binning reading from pixels 120 connected to a vertical signal line 132.

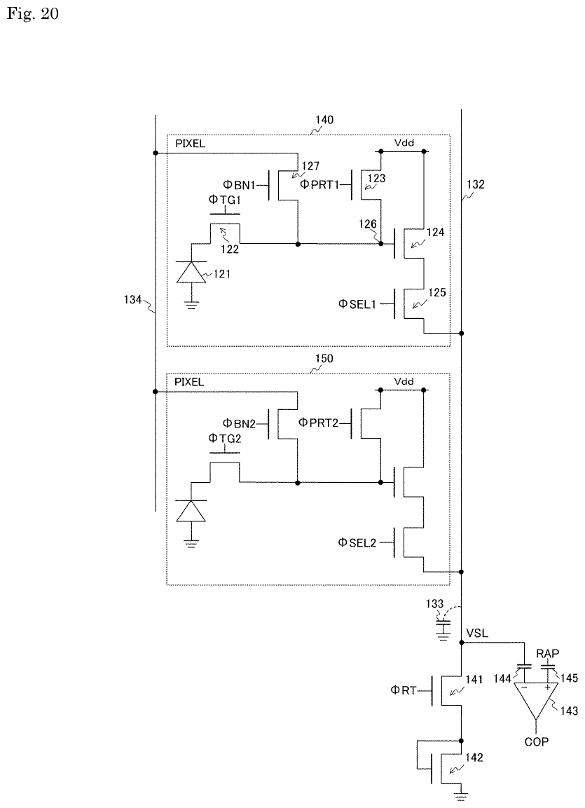

FIG. 20 illustrates a configuration example of a signal reading circuit for each column according to the tenth embodiment.

In FIG. 20, the signal reading circuit includes pixels 140 and 150 instead of the pixel 120 of the signal reading circuit of the first embodiment. Moreover, the signal reading circuit is configured such that a binning line 134 is added to the signal reading circuit of the first embodiment. The other configurations of the signal reading circuit of the tenth embodiment are identical to the configuration of the signal reading circuit of the first embodiment.

The pixels 140 and 150 are configured such that a binning transistor 127 is added to the pixel 120 of the first embodiment. The other configurations of the pixels 140 and 150 of the tenth embodiment are identical to the configuration of the pixel 120 of the first embodiment.

The binning transistor 127 for each of the pixels 140 and 150 is connected between a floating diffusion 126 and the binning line 134. The binning transistor 127 may be a MOS transistor. To the gate of the binning transistor 127, binning signals ΦBN1 and ΦBN2 are applied for the respective pixels 140 and 150. To the gate of a transfer transistor 122, transfer signals ΦTG1 and ΦTG2 are applied for the respective pixels 140 and 150. To the gate of a reset transistor 123, pixel reset signals ΦPRT1 and ΦPRT2 are applied for the respective pixels 140 and 150. To the gate of a selection transistor 125, selection signals ΦSEL1 and ΦSEL2 are applied for the respective pixels 140 and 150.

When the signals are read from the respective pixels 140 and 150, the binning signals ΦBN1 and ΦBN2 are set at a low level, and the binning transistor 127 of each of the pixels 140 and 150 is turned off. In the case of binning reading of the signals from the respective pixels 140 and 150, the binning signals ΦBN1 and ΦBN2 are set at a high level, and the binning transistor 127 of each of the pixels 140 and 150 is turned on. A capacitive load reading operation from the pixels 140 and 150 is identical to that of FIG. 7. At this point, in binning reading, any one of the selection transistors 125 of the pixels 140 and 150 may be turned on, or both of the selection transistors 125 of the pixels 140 and 150 may be turned on.

As described above, in the tenth embodiment, the binning transistor 127 is provided in each of the pixels 140 and 150 connected to the vertical signal line 132. This can apply capacitive load reading while reducing the number of times of reading in each frame, thereby reducing power consumption.

Moreover, any one of the configurations of the second to ninth embodiments may be applied to a configuration including the pixels 140 and 150.

### 11. Eleventh Embodiment

In the first embodiment, a signal read from the pixel 120 is detected on the basis of the potential VSL of the vertical signal line 132 connected to the pixel 120. In an eleventh embodiment, edge detection is performed on the basis of the comparison result of the potentials of vertical signal lines, the potentials being based on load capacitive reading from different columns.

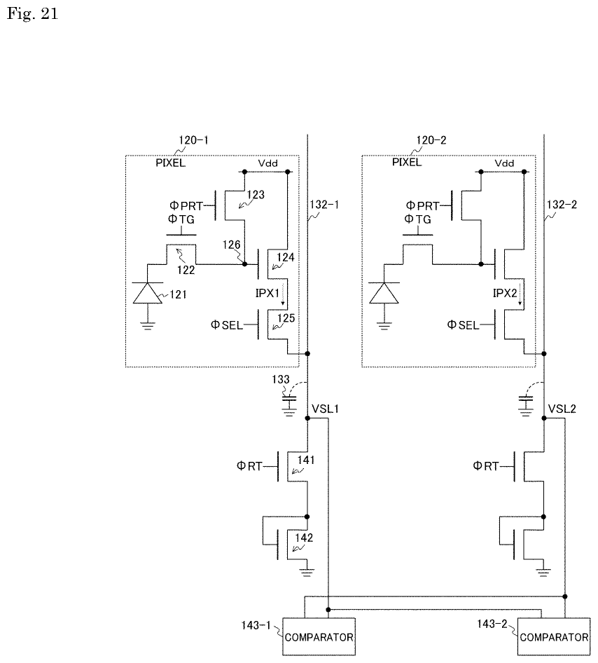

FIG. 21 illustrates a configuration example of a signal reading circuit for two columns according to the eleventh embodiment.

In FIG. 21, the signal reading circuit includes multiple vertical signal lines 132-1 and 132-2, and comparators 143-1 and 143-2 instead of the comparator 143 of the first embodiment. The other configurations of the signal reading circuit of the eleventh embodiment are identical to the configuration of the signal reading circuit of the first embodiment.

Pixels 120-1 and 120-2 are connected to the vertical signal lines 132-1 and 132-2, respectively. The vertical signal lines 132-1 and 132-2 are connected to the comparators 143-1 and 143-2, respectively.

The pixels 120-1 and 120-2 can be configured like the pixel 120 of FIG. 6. The pixels 120-1 and 120-2 are connected to the vertical signal lines 132-1 and 132-2, respectively. Moreover, a diode-connected transistor 142 is connected to each of the vertical signal lines 132-1 and 132-2 via a signal line transistor 141. The comparators 143-1 and 143-2 compare potentials VLS1 and VLS2 of the vertical signal lines 132-1 and 132-2. When a difference between the potentials VLS1 and VLS2 of the vertical signal lines 132-1 and 132-2 is equal to or larger than a threshold value, it can be determined that an edge is present.

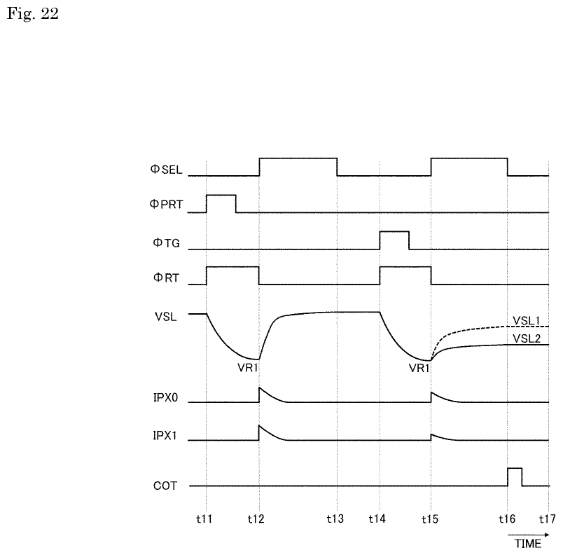

FIG. 22 shows an example of a waveform of each unit during signal reading of an imaging device according to the eleventh embodiment.

In FIG. 22, a capacitive load reading operation is identical to that of FIG. 7. However, in the eleventh embodiment, pixel currents IPX1 and IPX2 pass through the respective vertical signal lines 132-1 and 132-2 when signals are read from the pixels 120-1 and 120-2. At this point, charges corresponding to the pixel currents IPX1 and IPX2 for the respective vertical signal lines 132-1 and 132-2 are accumulated in capacitors 133. Thereafter, potentials VSL1 and VSL2 of the vertical signal lines 132-1 and 132-2 change according to the charges accumulated in the capacitors 133 of the vertical signal lines 132-1 and 132-2 and are input to the comparators 143-1 and 143-2, respectively. When a comparison signal COT rises in the comparators 143-1 and 143-2 (t16), the potentials VSL1 and VSL2 of the vertical signal lines 132-1 and 132-2 are compared with each other, and the comparison result is output.

As described above, in the eleventh embodiment, each of the comparators 143-1 and 143-2 detects a difference between the potentials VLS1 and VLS2 of the vertical signal lines 132-1 and 132-2, the potentials VLS1 and VLS2 being based on load capacitive reading. This can detect the edge of a subject while reducing power consumption.

### 12. Twelfth Embodiment

In the first embodiment, the diode-connected transistor 142 is connected to the signal line transistor 141 electrically connected to the vertical signal line 132 that transmits the signal read from the pixel 120. In a twelfth embodiment, a substrate where a solid-state imaging device is formed is laminated, the solid-state imaging device including a pixel array unit having pixels 120 arranged in a matrix form.

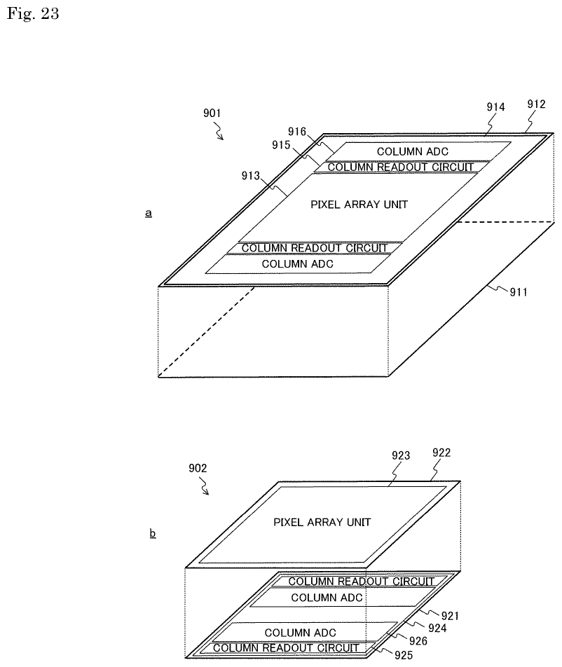

FIG. 23 is a perspective view illustrating a configuration example of the imaging device according to the twelfth embodiment.

In a of FIG. 23, a solid-state imaging device 901 includes a support substrate 911 and a semiconductor substrate 912. The semiconductor substrate 912 is stacked on the support substrate 911. On the semiconductor substrate 912, a pixel array unit 913 and a peripheral circuit 914 are formed. In the peripheral circuit 914, a column readout circuit 915 and a column ADC 916 are formed. The column readout circuit 915 and the column ADC 916 may be formed on both sides of the pixel array unit 913 in the column direction.

In the pixel array unit 913, the pixels 120 are arranged in a matrix form along the row direction and the column direction. The column readout circuit 915 can read signals from the pixels 120 on the basis of capacitive load reading. In the column readout circuit 915, for example, the signal line reset transistor 141 and the diode-connected transistor 142 of FIG. 6 may be formed. The column ADC 916 can perform AD conversion for each column on a signal read through the column readout circuit 915. At this point, the solid-state imaging device 901 can configure a back-illuminated image sensor.

In b of FIG. 23, a solid-state imaging device 902 includes semiconductor substrates 921 and 922. The semiconductor substrate 922 is stacked on the semiconductor substrate 921. On the semiconductor substrate 922, a pixel array unit 923 is formed. On the semiconductor substrate 922, a peripheral circuit 924 is formed. In the peripheral circuit 924, a column readout circuit 925 and a column ADC 926 are formed. The column readout circuit 925 and the column ADC 926 may be formed at the positions of both sides of the pixel array unit 923 in the column direction. At this point, the solid-state imaging device 902 can configure a back-illuminated image sensor.

As described above, in the twelfth embodiment, the substrates on which the solid-state imaging devices 901 and 902 are formed are stacked. This configuration can reduce the thicknesses of the semiconductor substrates 912 and 922 on which the pixel array units 913 and 923 are formed while supporting the pixel array units 913 and 923, and form the back-illuminated image sensor.

### 13. Example of Application to Mobile Object

The technique according to the present disclosure (the present technique) can be applied to various products. For example, the technique according to the present disclosure may be implemented as a device equipped in any type of mobile object such as an automobile, an electric vehicle, a hybrid electric vehicle, a motorcycle, a bicycle, a personal mobility device, an airplane, a drone, a ship, and a robot.

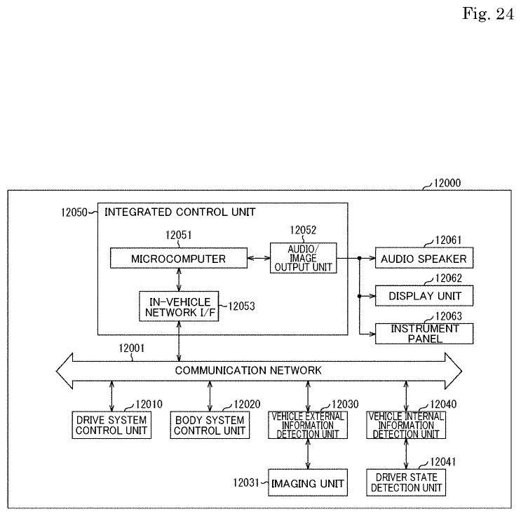

FIG. 24 is a block diagram showing a schematic configuration example of a vehicle control system that is an example of a mobile object control system to which the technique according to the present disclosure can be applied.

A vehicle control system 12000 includes a plurality of electronic control units connected via a communication network 12001. In the example illustrated in FIG. 24, the vehicle control system 12000 includes a drive system control unit 12010, a body system control unit 12020, a vehicle external information detection unit 12030, a vehicle internal information detection unit 12040, and an integrated control unit 12050. In addition, as a functional configuration of the integrated control unit 12050, a microcomputer 12051, an audio/image output unit 12052, and an in-vehicle network I/F (interface) 12053 are illustrated.

The drive system control unit 12010 controls an operation of an apparatus related to a drive system of a vehicle according to various programs. For example, the drive system control unit 12010 functions as a driving force generator for generating a driving force of the vehicle such as an internal combustion engine or a driving motor, a driving force transmission mechanism for transmitting a driving force to wheels, a steering mechanism for adjusting a turning angle of the vehicle, and a control device such as a braking device that generates a braking force of the vehicle.

The body system control unit 12020 controls operations of various devices mounted in the vehicle body according to various programs. For example, the body system control unit 12020 functions as a control device of a keyless entry system, a smart key system, a power window device, or various lamps such as a headlamp, a back lamp, a brake lamp, a turn signal, and a fog lamp. In this case, radio waves transmitted from a portable device that substitutes for a key or signals of various switches may be input to the body system control unit 12020. The body system control unit 12020 receives inputs of the radio waves or signals and controls a door lock device, a power window device, and a lamp of the vehicle.

The vehicle external information detection unit 12030 detects information on the outside of the vehicle having the vehicle control system 12000 mounted thereon. For example, an imaging unit 12031 is connected to the vehicle external information detection unit 12030. The vehicle external information detection unit 12030 causes the imaging unit 12031 to capture an image of the outside of the vehicle and receives the captured image. The vehicle external information detection unit 12030 may perform object detection processing or distance detection processing for persons, cars, obstacles, signs, and letters on the road on the basis of the received image.

The imaging unit 12031 is an optical sensor that receives light and outputs an electrical signal according to the amount of the received light. The imaging unit 12031 can also output the electrical signal as an image or distance measurement information. In addition, the light received by the imaging unit 12031 may be visible light or invisible light such as infrared light.

The vehicle internal information detection unit 12040 detects information on the inside of the vehicle. For example, a driver state detection unit 12041 that detects a driver's state is connected to the vehicle internal information detection unit 12040. The driver state detection unit 12041 includes, for example, a camera that captures an image of a driver, and the vehicle internal information detection unit 12040 may calculate a degree of fatigue or concentration of the driver or may determine whether or not the driver is dozing on the basis of detection information input from the driver state detection unit 12041.

The microcomputer 12051 can calculate a control target value for the driving force generation device, the steering mechanism, or the braking device on the basis of vehicle external or internal information acquired by the vehicle external information detection unit 12030 or the vehicle internal information detection unit 12040, and can output a control command to the drive system control unit 12010. For example, the microcomputer 12051 can perform cooperative control for the purpose of implementing the functions of an ADAS (Advanced Driver Assistance System) including vehicle collision avoidance or impact mitigation, following traveling based on a following distance, vehicle speed maintenance travelling, a vehicle collision warning, or a vehicle lane departure warning.

Furthermore, the microcomputer 12051 can perform cooperative control for the purpose of automated driving or the like in which autonomous driving is performed without depending on operations of the driver, by controlling the driving force generator, the steering mechanism, or the braking device or the like on the basis of information about the surroundings of the vehicle, the information being acquired by the vehicle external information detection unit 12030 or the vehicle internal information detection unit 12040.

In addition, the microcomputer 12051 can output a control command to the body system control unit 12020 on the basis of vehicle external information acquired by the vehicle external information detection unit 12030. For example, the microcomputer 12051 can perform cooperative control for the purpose of preventing glare, such as switching from a high beam to a low beam, by controlling the headlamp according to the position of a vehicle ahead or an oncoming vehicle detected by the vehicle external information detection unit 12030.

The audio/image output unit 12052 transmits an output signal of at least one of sound and an image to an output device capable of visually or audibly notifying a passenger or the outside of the vehicle of information. In the example of FIG. 24, as an output device, an audio speaker 12061, a display unit 12062, and an instrument panel 12063 are illustrated. The display unit 12062 may include, for example, at least one of an onboard display and a head-up display.

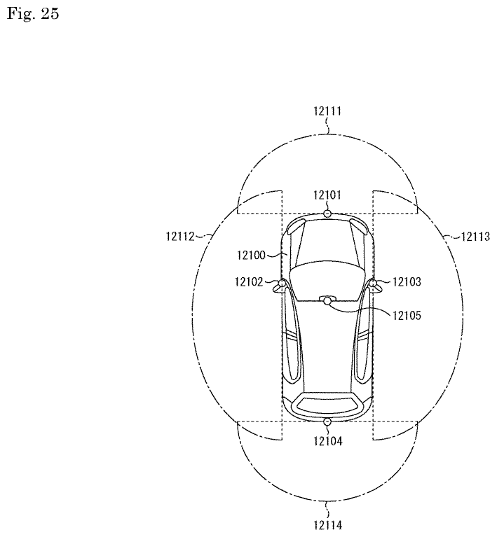

FIG. 25 illustrates an example of the installation positions of the imaging unit 12031.

In FIG. 25, imaging units 12101, 12102, 12103, 12104, and 12105 are provided as the imaging unit 12031.

For example, the imaging units 12101, 12102, 12103, 12104, and 12105 are provided at positions such as a front nose, side-view mirrors, a rear bumper, a back door, and an upper portion of a windshield in the vehicle interior of the vehicle 12100. The imaging unit 12101 provided on the front nose and the imaging unit 12105 provided in the upper portion of the windshield in the vehicle interior mainly acquire images of the front of the vehicle 12100. The imaging units 12102 and 12103 provided on the side-view mirrors mainly acquire images of a lateral side of the vehicle 12100. The imaging unit 12104 provided on the rear bumper or the back door mainly acquires images of the rear of the vehicle 12100. The imaging unit 12105 provided on an upper part of the windshield in the vehicle is mainly used for detecting vehicles ahead, pedestrians, obstacles, traffic signals, traffic signs, or lanes and the like.

FIG. 25 shows an example of the imaging ranges of the imaging units 12101 to 12104. An imaging range 12111 indicates the imaging range of the imaging unit 12101 provided at the front nose, imaging ranges 12112 and 12113 respectively indicate the imaging ranges of the imaging units 12102 and 12103 provided at the side-view mirrors, and an imaging range 12114 indicates the imaging range of the imaging unit 12104 provided at the rear bumper or the back door. For example, by superimposing image data captured by the imaging units 12101 to 12104, a bird's-eye view image viewed from the upper side of the vehicle 12100 can be obtained.

At least one of the imaging units 12101 to 12104 may have the function of obtaining distance information. For example, at least one of the imaging units 12101 to 12104 may be a stereo camera including a plurality of imaging elements or may be an imaging element having pixels for phase difference detection.

For example, the microcomputer 12051 can extract, particularly, the closest three-dimensional object on a path along which the vehicle 12100 is traveling, that is, a three-dimensional object traveling at a predetermined speed (for example, 0 km/h or higher) in the substantially same direction as the vehicle 12100, as a vehicle ahead by acquiring a distance to each three-dimensional object in the imaging ranges 12111 to 12114 and a temporal change of this distance (a relative speed with respect to the vehicle 12100) on the basis of the distance information obtained from the imaging units 12101 to 12104. Furthermore, the microcomputer 12051 can set a distance to be secured from a vehicle ahead in advance and can perform automated brake control (also including following stop control) or automated acceleration control (also including following start control). In this way, cooperative control can be performed for the purpose of automated traveling or the like in which autonomous driving can be performed without depending upon the operations of the driver.

For example, the microcomputer 12051 can classify three-dimensional data regarding three-dimensional objects into two-wheeled vehicles, normal vehicles, large vehicles, pedestrians, and other three-dimensional objects such as electric poles and extract the information on the basis of distance information obtained from the imaging unit 12101 to 12104. The three-dimensional data can be used for automated avoidance of obstacles. For example, the microcomputer 12051 differentiates obstacles around the vehicle 12100 as obstacles that can be viewed by the driver of the vehicle 12100 and obstacles that are difficult to view. The microcomputer 12051 then determines a collision risk indicating the degree of risk of collision with each obstacle. When the collision risk is equal to or higher than a set value and there is a possibility of collision, an alarm is output to the driver through the audio speaker 12061 or the display unit 12062, forced deceleration or avoidance steering is performed through the drive system control unit 12010, thereby providing driving support for collision avoidance.

At least one of the imaging units 12101 to 12104 may be an infrared camera that detects infrared rays. For example, the microcomputer 12051 can recognize pedestrians by determining the presence or absence of pedestrians in captured images of the imaging unit 12101 to 12104. Such pedestrian recognition is performed by, for example, the step of extracting feature points in the captured images of the imaging units 12101 to 12104 acting as infrared cameras and the step of determining whether an object is a pedestrian or not by performing pattern matching processing on a series of feature points indicating an outline of the object. When the microcomputer 12051 determines the presence of a pedestrian in the captured images of the imaging units 12101 to 12104 and recognizes the pedestrian, the audio/image output unit 12052 controls the display unit 12062 such that a square contour line for emphasis is superimposed on the recognized pedestrian. In addition, the audio/image output unit 12052 may control the display unit 12062 such that an icon or the like of a pedestrian is displayed at a desired position.

An example of the vehicle control system to which the technique according to the present disclosure can be applied has been described above. The technique according to the present disclosure can be applied to the imaging unit 12031 among the configurations described above. Specifically, for example, the camera 100 can be applied to the imaging unit 12031. The application of the technique according to the present disclosure to the vehicle control system 12000 can obtain captured images while suppressing an increase in power consumption, and prevent a sunspot phenomenon.

It should be noted that the above-described embodiments show examples for embodying the present technique, and matters in the embodiments and matters specifying the invention in the claims have a corresponding relationship. Likewise, the matters specifying the invention in the claims and the matters having the same names in the embodiments of the present technique have a corresponding relationship. However, the present technique is not limited to the embodiments and can be embodied by applying various modifications to the embodiments without departing from the gist thereof. Furthermore, the effects described in the present specification are merely exemplary and not intended to be limited, and other effects may be provided as well.

The present technique can also be configured as follows:
(1) An imaging device including:
   a signal line that changes in potential on the basis of a charge accumulated according to a current passing when a signal is read from a pixel;
   a signal line transistor electrically connected to the signal line; and
   a voltage generation unit connected in series to the signal line transistor and being capable of generating a voltage higher than 0 V.
(2) The imaging device according to (1), wherein the potential of the signal line is the potential of the parasitic capacitance of the signal line.
(3) The imaging device according to (1) or (2), wherein the pixel includes: a photodiode;
   a transfer transistor that transfers a charge accumulated in the photodiode to a floating diffusion;
   a reset transistor that resets the floating diffusion;
   an amplification transistor that outputs a signal corresponding to the potential of the floating diffusion; and
   a selection transistor connected between the amplification transistor and the signal line.
(4) The imaging device according to any one of (1) to (3), wherein the voltage generation unit includes a diode-connected transistor.
(5) The imaging device according to any one of (1) to (3), wherein the voltage generation unit includes a plurality of diode-connected transistors connected in series in varying numbers.
(6) The imaging device according to any one of (1) to (5), wherein the voltage generation unit sets the reset level of the signal line upon reading of a reset level from the pixel such that the reset level of the signal line is equal to or higher than a reset level of the signal line upon reading of a signal level from the pixel.
(7) The imaging device according to any one of (1) to (6), further including a comparator that compares the potential of the signal line and a ramp signal.
(8) The imaging device according to any one of (1) to (7), further including a comparator that compares the potentials of the signal lines provided in different columns.
(9) The imaging device according to any one of (1) to (8), further including a constant current transistor that is electrically connectable to the signal line and passes a constant current on the basis of a source follower formed between the pixel and the constant-current transistor.
(10) The imaging device according to (9), wherein
   the constant current transistor is turned on in constant-current reading using the constant-current transistor, and
   the constant-current transistor is turned off in capacitive load reading using the voltage generation unit.
(11) The imaging device according to any one of (1) to (8), further including
   a sample hold circuit that operates the signal line transistor as a constant-current transistor; and
   a switch that switches the connection of the signal line transistor between the voltage generation unit and the ground potential.
(12) The imaging device according to (11), wherein
   in constant current reading, the connection of the signal line transistor is switched to the ground potential and the signal line transistor is turned on, and
   in capacitive load reading, the connection of the signal line transistor is switched to the voltage generation unit and the signal line transistor is turned off after the signal line is reset.
(13) The imaging device according to any one of (1) to (8), wherein the voltage generation unit includes:
   a series transistor connected in series to the signal line transistor; and
   a switching transistor that switches between the gate and drain of the series transistor.
(14) The imaging device according to (13), wherein
   the switching transistor is turned off in constant-current reading, and
   the switching transistor is turned on in capacitive load reading.
(15) The imaging device according to any one of (1) to (14), further including a chip on which the pixel is formed, wherein
   the signal line transistor is formed on the chip.
(16) The imaging device according to (15), wherein the voltage generation unit is formed on the chip.
(17) The imaging device according to any one of (1) to (16), further including a pixel array unit including the pixels arranged in a matrix form in the row direction and
   the column direction, wherein
   the plurality of signal lines are provided in the row direction such that the signal lines are routed in the column direction, and
   the signal line transistor is provided for each of the signal lines.
(18) The imaging device according to (17), wherein the voltage generation unit is provided for each of the signal lines in different columns.
(19) The imaging device according to (17), wherein the voltage generation unit is shared among the plurality of signal lines in different columns.
(20) The imaging device according to (18), further including a short-circuit line that short-circuits the voltage generation unit provided for each of the signal lines in different columns.

### REFERENCE SIGNS LIST

100 Camera
101 Optical system
102 Solid-state imaging device
103 Imaging control unit
104 Image processing unit
105 Storage unit
106 Display unit
107 Operation unit
108 Bus
111 Pixel array unit
112 Vertical scanning circuit
113 Column readout circuit
114 Column signal processing unit
115 Horizontal scanning circuit
116 Control circuit
121 Photodiode
122 Transfer transistor
123 Reset transistor
124 Amplification transistor
125 Selection transistor
126 Floating diffusion
131 Horizontal driving line
132 Vertical signal line
133 Capacitor
141 Signal line transistor
142 Diode-connected transistor
143 Comparator
144, 145 DC-cut capacitor

1. An imaging device comprising:
a signal line that changes in potential on the basis of a charge accumulated according to a current passing when a signal is read from a pixel;
a signal line transistor electrically connected to the signal line; and
a voltage generation unit connected in series to the signal line transistor and being capable of generating a voltage higher than 0 V.

2. The imaging device according to claim 1, wherein the potential of the signal line is a potential of a parasitic capacitance of the signal line.

3. The imaging device according to claim 1, wherein the pixel includes:
a photodiode;
a transfer transistor that transfers a charge accumulated in the photodiode to a floating diffusion;
a reset transistor that resets the floating diffusion;
an amplification transistor that outputs a signal corresponding to a potential of the floating diffusion; and
a selection transistor connected between the amplification transistor and the signal line.

4. The imaging device according to claim 1, wherein the voltage generation unit includes a diode-connected transistor.

5. The imaging device according to claim 1, wherein the voltage generation unit includes a plurality of diode-connected transistors connected in series in varying numbers.

6. The imaging device according to claim 1, wherein the voltage generation unit sets a reset level of the signal line upon reading of a reset level from the pixel such that the reset level of the signal line is equal to or higher than a reset level of the signal line upon reading of a signal level from the pixel.

7. The imaging device according to claim 1, further comprising a comparator that compares the potential of the signal line and a ramp signal.

8. The imaging device according to claim 1, further comprising a comparator that compares the potentials of the signal lines provided in different columns.

9. The imaging device according to claim 1, further comprising a constant-current transistor that is electrically connectable to the signal line and passes a constant current on the basis of a source follower formed between the pixel and the constant-current transistor.

10. The imaging device according to claim 1, wherein
the constant-current transistor is turned on in constant-current reading using the constant-current transistor, and
the constant-current transistor is turned off in capacitive load reading using the voltage generation unit.

11. The imaging device according to claim 1, further comprising
a sample hold circuit that operates the signal line transistor as a constant-current transistor; and
a switch that switches a connection of the signal line transistor between the voltage generation unit and a ground potential.

12. The imaging device according to claim 11, wherein
in constant current reading, the connection of the signal line transistor is switched to the ground potential and the signal line transistor is turned on, and
in capacitive load reading, the connection of the signal line transistor is switched to the voltage generation unit and the signal line transistor is turned off after the signal line is reset.

13. The imaging device according to claim 1, wherein the voltage generation unit includes:
a series transistor connected in series to the signal line transistor; and
a switching transistor that switches between a gate and drain of the series transistor.

14. The imaging device according to claim 13, wherein
the switching transistor is turned off in constant-current reading, and
the switching transistor is turned on in capacitive load reading.

15. The imaging device according to claim 1, further comprising a chip on which the pixel is formed, wherein
the signal line transistor is formed on the chip.

16. The imaging device according to claim 15, wherein the voltage generation unit is formed on the chip.

17. The imaging device according to claim 1, further comprising a pixel array unit including the pixels arranged in a matrix form in a row direction and a column direction, wherein
the plurality of signal lines are provided in the row direction such that the signal lines are routed in the column direction, and
the signal line transistor is provided for each of the signal lines.

18. The imaging device according to claim 17, wherein the voltage generation unit is provided for each of the signal lines in different columns.

19. The imaging device according to claim 17, wherein the voltage generation unit is shared among the plurality of signal lines in different columns.

20. The imaging device according to claim 18, further comprising a short-circuit line that short-circuits the voltage generation unit provided for each of the signal lines in different columns.
